(19) United States
(12) Patent Application Publication
(10) Pub. No.: US 2007/0127489 A1
(43) Pub. Date: Jun. 7, 2007

(54) Apparatus and method for the optimal utilization and delivery of multiple applications over a digital subscriber loop

(76) Inventors: Nestor A. Amaya, Kanata (CA); Michael Wingrove, Kanata (CA); Martin Bijman, Stittsville (CA)

Correspondence Address: MEREK, BLACKMON & VOORHEES, LLC, 673 S. WASHINGTON ST., ALEXANDRIA, VA, 22314, US

(21) Appl. No.: 11/281,423

(22) Filed: Nov. 18, 2005

(51) Int. Cl. H04L 12/56; H04L 12/28

(52) U.S. Cl. 370/395.2; 370/398

(57) ABSTRACT

An apparatus and method for optimizing the utilization and the delivery of multiple applications over a Digital Subscriber Loop (DSL). The apparatus detects the type of media being delivered in each Protocol Data Unit (PDU) over a Digital Subscriber Loop (DSL) and switches or otherwise directs the PDU to a Virtual Circuit (VC) on the DSL best suited for that type of media. The apparatus allows for the delivery of multiple applications to the Customer Premises Equipment (CPE) requiring VCs of differing profile or characteristic. Another aspect of the present invention includes an apparatus and method for dynamically re-partitioning the bandwidth allocated to each VC of differing profile on the DSL, for the purposes of optimizing and utilizing all available bandwidth on the DSL. By dynamically re-partitioning the bandwidth allocated to each VC of differing profile, the DSL Provider is able to provision a generic Virtual Path (VP) for every DSL Subscriber at deployment which consists of a collection of VCs, such that each VC will subsequently adapt to each individual Subscriber usage, and not require additional external circuits or products to condition the information in order to provide a Quality of Service (QoS) expected for each application by the Subscriber.

### FIELD OF THE INVENTION

The present invention is directed generally to communication networks and delivery of information over a Digital Subscriber Loop (DSL). More specifically, the present invention is directed to an improved method and apparatus for conveying multiple applications to and/or from the Customer Premises Equipment (CPE) requiring Virtual Circuits (VC) or other data paths of differing profiles or characteristics. Another aspect of the present invention is directed to an apparatus and method for dynamically re-partitioning the bandwidth allocated to each VC of differing profile on the DSL in order to optimize and utilize all available bandwidth on the DSL.

### BACKGROUND OF THE INVENTION

A conventional information delivery environment is represented generally by item 100 in FIG. 1. As seen in FIG. 1, in conventional information delivery environments, Subscribers of information services have on their premises Customer Premises Equipment (CPE) 150 which is served by a Digital Subscriber Loop (DSL) 141. The CPE 150 carries data on a shared subscriber network 151 to enable the Subscriber to use voice services 180 on a SIP phone for example, streaming audio 170 such as radio or other broadcasts, internet-based games 190, and internet surfing 191 on a personal computer for example, and other applications, that have content provided on a connection to the internet supplied by an Internet Service Provider (ISP) 110 for example. The Subscriber may additionally experience television 160 usually through a Set Top Box (STB) 161 that has content typically broadcast to the Subscriber or selected with Video on Demand service from a Video Service Provider (VSP) 120. These applications are different in nature and require a Virtual Circuit (VC) that has characteristics best suited for that application. For example, many applications run from ISP data are connected on a VC with low latency 142 referred to as fastpath. The low latency is important for quick response to user inputs such as for gaming, whereas applications run from VSP data connected applications, like video, require greater resistance to noise interference in the DSL domain to obtain sufficient QoS for the intended application, thus requiring greater error correction in the DSL VC that results in high latency 143 referred to as slowpath. DSL Providers deliver the DSL 141 from circuits at a Central Office (CO) 140, and generally many such CO circuits are aggregated on a Broadband Remote Access System (BRAS) 130 that provides Connection, Administration, and Control (CAC) to service the connection of each Subscriber to the ISPs 110 and VSPs 120.

DSL Providers currently allocate bandwidth on a DSL in fixed proportions, based on the services that are being sold to the Subscriber. Typically the VC to each video STB 161 is provisioned with slowpath 143 to consume a particular fixed bandwidth Variable Bit Rate—Real Time (VBR-RT) VC on the DSL depending on the type of video subscribed, similarly this is repeated for each video channel required on the DSL. After all video applications are provisioned on the DSL 141, the remaining bandwidth on the DSL 141 is provisioned as Uncommitted Bit Rate (UBR) or generic VC 142 for use by the Subscriber for typically all other applications which are connected to the ISP 110. Since applications like gaming require fastpath, the remaining UBR channel is provisioned as fastpath. Once provisioned by the DSL Provider, these VCs remain static for each Subscriber indefinitely.

It is also a common practice of DSL Providers to simplify their networks and provisioning of DSL services by providing only one type of VC in the DSL, most often fastpath. This situation is shown generally by item 200 in FIG. 2. In this case, the additional error correction to improve noise immunity required for the delivery of data for video to STB 161 must add external bookended Impulse Noise Protection (INP) circuits in series with the VSP 120 with INP block 201 and in series with the STB 161 with INP block 202.

There are a number of shortcomings with the current art for the delivery of multiple applications over a single DSL to a Subscriber. When considering that all video VCs are not always in use at all times, it is apparent that the practice of the fixed provisioning of DSL bandwidth for video channels followed by the provisioning the balance of DSL bandwidth for all other applications is rigid and an inefficient use of bandwidth in that this does not allow the unused video bandwidth to be used for other applications. When a DSL link is provisioned with only one VC of low latency primarily to serve gaming applications, the delivery of other applications like video which require better immunity to noise require external circuits to add impulse noise protection to the transported data, which adds cost. Also, the rigidly provisioned VCs dedicated to a specific ISP or VSP, as required to accommodate the characteristics of the VC required to deliver the respective data, reduces the flexibility and choice of Subscribers to select from different ISPs or VSPs. For the DSL Provider, the requirement to provision each DSL VC for a specific collection of video channels and other applications sold to each Subscriber further complicate the provisioning process as it requires knowledge of each Subscriber installation, perhaps by survey or questionnaire when service is ordered or altered. Hence, further operation activities are necessary including collecting, provisioning, and administering the selections of each Subscriber all of which are prone to human error, and all of which add operation cost and slow the delivery of services.

### OBJECTS AND SUMMARY OF THE INVENTION

An object of the preferred embodiments of the present invention is to obviate or mitigate one or more of the disadvantages inherent in conventional information delivery environments explained above.

In accordance with a preferred embodiment of the present invention, there is provided an apparatus which enhances the CO circuits delivering the DSL to the Subscriber. Preferably, for each Protocol Data Unit (PDU), the apparatus detects and classifies the type of media in the PDU and thus the corresponding type of application. Based on the detected media classification, the apparatus switches the PDU to a Virtual Circuit on the DSL that is suitable for that type of media PDU. In accordance with another preferred embodiment of the present invention there is provided an apparatus and method for monitoring each category of Virtual Circuit on the DSL to determine over a period of aggregation the relative utilization of each category of Virtual Circuit, and implementing a method or algorithm to dynamically re-provision the bandwidth of each Virtual Circuit periodically to reduce the bandwidth of underutilized Virtual Circuits and/or increase the size of categories of Virtual Circuits when increased data traffic for the Virtual Circuit increases. In accordance with further aspects of the preferred embodiments of the present invention, like concepts are applied at different parts of the information delivery environment, including, the Broadband Remote Access Server (BRAS), and the Subscriber CPE.

### BRIEF DESCRIPTION OF THE DRAWINGS

FIG. 1 is a block diagram of a prior art information delivery system with fixed provisioning of Virtual Circuits to deploy video and other applications with an acceptable quality of service.

FIG. 2 is a block diagram representing an alternate prior art provisioning model where only one DSL Virtual Circuit is used requiring additional external circuits to add impulse noise protection to deliver video with acceptable quality of service.

FIG. 3 is a block diagram representing aspects of the present invention as implemented in the CO circuits.

FIG. 4 is a block diagram representing additional aspects of the present invention as implemented in BRAS circuits.

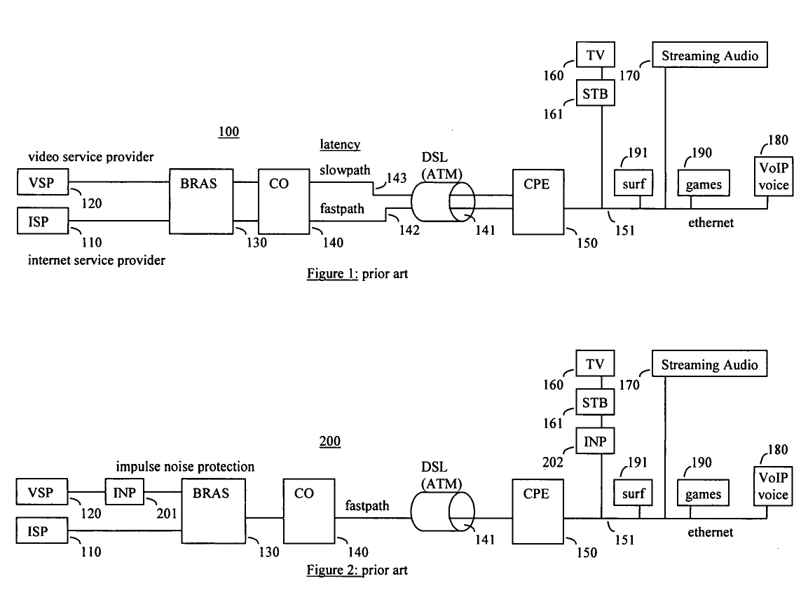

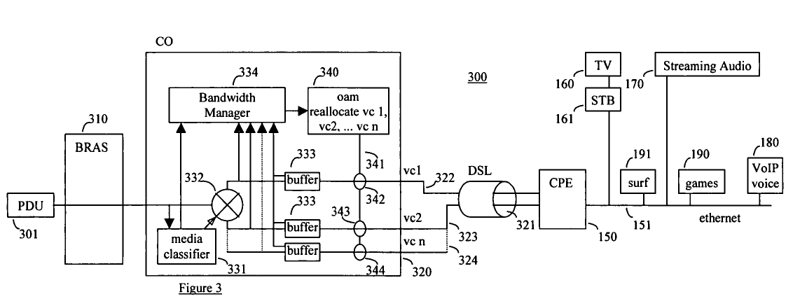

### DETAILED DESCRIPTION OF THE PREFERRED EMBODIMENTS OF THE INVENTION

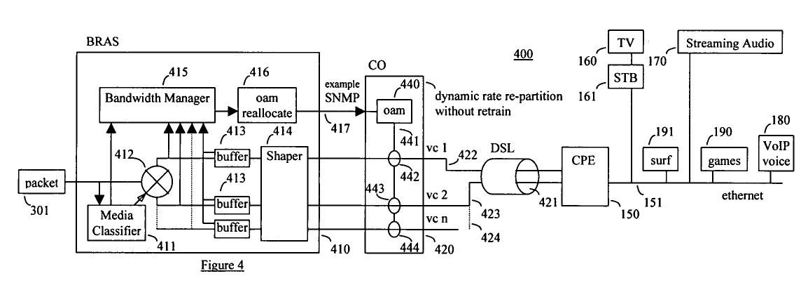

The preferred forms of the invention will now be described with reference to FIGS. 3 and 4. The appended claims are not limited to the preferred forms and no term and/or phrase used herein is to be given a meaning other than its ordinary meaning unless it is expressly stated otherwise.

### FIG. 3

Referring to FIG. 3, information in the form of Protocol Data Unit (PDU) 301 enter the CO 320. Acceptable forms of PDUs include, but are not limited to, ATM cells, IP packets, or Ethernet frames. The Media Classifier 331 inspects each PDU entering the DSL CO circuits, to seek specific aspects of the PDU to determine the application on which the PDU is destined. Preferably, the Media Classifier inspects the PDU using a Protocol Filter Engine. Preferably, the engine is structured as “n” parallel search trees, with each search tree being able to perform a maximum of “M” word comparisons on the incoming PDU. A match can be done on a word pattern of one or several bytes, and the value “mₒ” determines the number of potential matches in one search. Each match within a tree can be offset by a programmable offset of “yₘ” bytes per match, such that the sum of each “yₘ” over “M” matches determines the depth of the search tree over the PDU. In the case of Ethernet frames used as the Layer 2 protocol, the Protocol Filter is preferably configured on a per-frame basis using a value returned by a MAC-VLAN table look-up. In this way, sub-sets of search trees are selected on a per-PDU connection basis. If one or more parallel searches are configured for a given connection, then the Protocol Filter linearly searches the frame, starting with Layer 2 fields and potentially looking deeply into the application layers within the payload. This way, video frames that may be defined to be MPEG2 over IP over Ethernet, for example, could be found. Likewise for voice (G.711 over IP), games, internet surf (TCP/IP/PPPoE) and/or other applications. Using this technique, the Media Classifier will distinguish if the PDU is destined for applications for video, streaming audio, voice, compressed voice, games, internet surfing, or other applications.

Referring to FIG. 3, switch 332 moves each PDU to an appropriate VC, based on the classification of the media as determined by the Media Classifier. PDUs may be transported on the DSL on one of many available profiles of VC such as vc1 322, vc2 323, vcn 324 using switch 332, for example, video application PDUs may all be switched to vc1 322 which may be provisioned with greater error correction, gaming application PDUs may all be switched to vc2 323 which may be provisioned for less or no error correction, and PDUs for other applications may be switched to vcn 324 which may be provisioned with particular characteristics that may be favorable to the transmission of said PDUs including another compromise error correction setting, or other parameters that may be selected in the DSL profile. For example, QoS requirements for high definition television may be more stringent than that for traditional television, thus, different VCs with differing levels for error correction may be provisioned for these applications.

The existing commercial CPE modems already deployed would be compatible with the invention as described, in that all ATM cells arriving on multiple VCs over the DSL are switched onto a shared network 151, which is usually ethernet but not limited to that protocol.

In yet another aspect of the present invention, the Media Classifier inspects all PDUs being transmitted to the Subscriber over DSL regardless of their source being either ISP, or VSP, or any other media provider. As a result, the Subscriber and DSL Provider are not bound to use specific ISP or VSP but rather may interact with many such providers, which gives the Subscriber and DSL Provider a wider choice of Service Provider.

In yet another aspect of the present invention, the Media Classifier provides a signal to the Bandwidth Manager each time a protocol data unit (PDU) requiring protection is switched. The Bandwidth Manager determines the appropriate allocation of bandwidth among the low latency, less protected VC, the higher latency, more protected VC, and any other VCs provisioned with differing characteristics. As the mechanisms for changing the allocation of bandwidth are slow compared with how fast the traffic content may change, the implementation of the Bandwidth Manager must have a fast attack and slow decay type of response. In other words when new data streams suitable for the protected path are identified by the Media Classifier the Bandwidth Manager must recognize the requirement for increased bandwidth on the selected path as quickly as possible; generally a response time on the order of milliseconds is required. On the other hand, when the data stream requiring protection ends the response of the Bandwidth Manager may be considerably slower; generally a response time on the order of seconds is acceptable. The Bandwidth Manager function can be more or less complex. Simple Bandwidth Manager implementations will rely on relatively crude estimates of the amount of bandwidth required for each stream requiring protection whereas more complex Bandwidth Manager functions will rely on a more complex and accurate estimates of the amount of bandwidth to allocate for the data streams requiring protection.

Referring to FIG. 3, the Bandwidth Manager 334 is added to the CO circuits 320. The signal from the Media Classifier 331 to the Bandwidth Manager 334 consists of any form of unique ID that allows the Bandwidth Manager to differentiate the traffic activity of a number of separate data streams. Examples of appropriate unique IDs are the ATM VPI/JVCIs, MAC Addresses, or IP Addresses associated with the stream or any reasonably compressed version thereof such as sub-ranges or hash codes generated from the aforementioned address fields. The Bandwidth Manager 334 implementation is described in subsequent paragraphs, from inputs from the Media Classifier as described, inspecting the current bandwidth setting of each of the differing VCs that are provisioned vcl 322, vc2 323, vcn 324, to instruct the DSL Operations Administration Maintenance (OAM) block to repartition the bandwidth of each VC, as symbolized by setting the VC bandwidth size with blocks 342 for vc1 322,343 for vc2 323, and 344 for vcn 324. Buffers 333 on each of the differing VCs may be used in a Bandwidth Manager implementation, as described in the subsequent paragraphs.

A relatively simple implementation of the Bandwidth Manager is described. The Bandwidth Manager starts a separate timer for each unique stream by setting a counter to some pre-defined positive constant. At regular intervals, of the order of every few milliseconds, the Bandwidth Manager decrements the counters towards zero and counts the number of active timers. Each time a new signal is received for an existing unique id, the associated timer is reset to the pre-defined positive constant, thus preventing timeout of that stream. If the number of active timers has changed from the previous interval the Bandwidth Manager recalculates the bandwidth to be allocated. The calculation in this case is extremely simple with the bandwidth required to be set equal to some provisioned bandwidth “quanta” multiplied by the number of active timers. Once the new value of bandwidth is calculated the Bandwidth Manager communicates the new requirement to the modem function used to implement the physical layer reconfiguration necessary to adjust the bandwidth. The “fast attack” response time for increasing the protected bandwidth is determined by the fundamental interval used to update the timers. The “slow decay” response time is the multiple of the fundamental timer interval times the value of the pre-defined timer constant.

An alternate implementation of the Bandwidth Manager is described. This implementation offers the benefit of automatic adjustment in situations where multiple streams with significantly different bandwidth requirements require protection. For example multiple video streams may require widely varying amounts of bandwidth depending on the video resolution (e.g., standard definition versus high definition) and whether the encoding is real-time or off line (e.g., off line encoding of video sources typically achieves higher efficiency than on line encoding of video sources). In this implementation, the signal from the Media Classifier consists of the unique ID and a value indicating the size of the PDU. The adaptive Bandwidth Manager instantiates a digital filter. The filter output is updated at some regularly spaced fundamental time interval (e.g., on the order of milliseconds and obeying the principal of uniform sampling). The input to the digital filter at the end of each interval is the sum of the size values received in all of the signals received since the end of the previous interval. If no signals were received since the previous interval a zero value is input to the filter. The resulting variable at the output of the filter is an estimate of the total “data unit size per unit time” as conditioned by the filter. The attack and decay times can be adjusted by appropriate selection of the filter coefficients. The “data unit size per unit time” is translated to a bandwidth requirement estimate by dividing it by the time interval. The new bandwidth requirement estimate is compared to the currently allocated bandwidth. If the new estimate is larger or smaller than the current bandwidth estimate by a provisioned minimum amount a new value for the current bandwidth estimate is calculated by adding a provisioned value of excess bandwidth margin to the new estimate and rounding the result to an acceptable level of precision. This comparison approach combined with the technique of adding an amount of excess margin when recalculating the current bandwidth estimate provides a degree of hysterysis. This hysterysis is helpful in reducing the rate of bandwidth change requests. Once the new value of bandwidth is calculated the Bandwidth Manager communicates the new requirement to the modem.

A third implementation of the Bandwidth Manager is described. In this implementation the benefit of automatic adjustment to variable data rates is provided. The Media Classifier does not provide a direct indication of traffic requiring protection to the Bandwidth Manager. Instead after identification by the Media Classifier the traffic requiring protection is routed to a buffering function 333. The Bandwidth Manager monitors the depth of the buffer and operates in a closed loop fashion to maintain a desired (typically shallow) buffer depth. In this method, in addition to the buffering function, the adaptive Bandwidth Manager instantiates a digital filter. The input to the filter in this case is a value representing the depth of the data queued in the buffer minus a provisioned buffer depth target. The buffer depth variable is effectively a scaled version of the integral over time of the difference between the data inflow rate minus the data outflow rate. The filter output is updated at some regularly spaced fundamental time interval (e.g., on the order of milliseconds and obeying the principal of uniform sampling). The resulting variable at the output of the filter is an estimate of the average error in matching the desired target buffer depth. If the magnitude of the average depth error exceeds a provisioned threshold then a new bandwidth for the protected channel is calculated. This threshold provides an adjustable amount of hysterysis or “deadband.” Different thresholds may be used for positive and negative errors in which case the hysterysis provided is asymmetric. The asymmetry may be adjusted together with the filter coefficients to control the attack and decay times. The new value of bandwidth is increased for positive errors and decreased for negative errors. As in method one, once the new value of bandwidth is calculated, the Bandwidth Manager communicates the new requirement to the modem. The bandwidth increase or decrease can be implemented as either a fixed delta relative to the current bandwidth or a value proportional to the error.

The following consideration is given on the Bandwidth Manager algorithm dynamics and buffering requirements. The reprovisioning of the bandwidth of the collection of VCs in the VP always involve a degree of latency due to the reprovisioning protocol implemented by the modem. Thus, when the ingress rate of traffic requiring protection increases, there is a transient period when the ingress rate of the protected data exceeds the egress rate. For the most robust operation a FIFO buffering should be provided to absorb the excess data that accumulates during the transients. Appropriate margining of the bandwidth headroom will ensure that the excess accumulated data will “drain out” of the buffer once the bandwidth is increased, thus preventing a sustained buildup of data in the buffer. An alternative approach may be considered where some degree of data loss is tolerable. In this case the excess data may be discarded until the modem physical layer completes the bandwidth allocation request.

### FIG. 4

In yet another aspect of the present invention, the invention can be implemented in different part of the information delivery network. Referring to FIG. 4, the invention can be realized as already described, with the addition that the bandwidth repartitioning determined by the Bandwidth Manager 415 would be communicated by a OAM Reallocate block 416 over a communication link to the CO circuits, which may be a management channel 417 for example, to the DSL CO OAM circuits 440. Also utilized in this implementation in the BRAS is a Shaper 414 that would prevent the VCs vc1 422, vc2 423, vcn 424 from getting too large, thus preventing any congestion at the CO. This implementation at other points between the Service Providers and the DSL block at the CO, other than the BRAS, can be implemented in a similar fashion by one skilled in the art.

In yet another aspect of the present invention, the same Media Classifier and Bandwidth Manager can be implemented in the CPE DSL modem for PDUs travelling upstream from the Subscriber to the CO.

Although the invention has been described with reference to certain specific embodiments, various modifications thereof will be apparent to those skilled in the art without departing from the spirit and scope of the invention as outlined in the claims appended hereto.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiments and have been written to preclude such a narrow construction using the principles of claim differentiation.

We claim:

1. A method of delivering information over an information communication network including a Digital Subscriber Loop, said method comprising the steps of:
(a) providing an information communication network including a Digital Subscriber Loop, said information communication network including a plurality of information paths, each of said plurality of information paths having at least one characteristic differentiating one information path from another information path;
(b) conveying information over said information communication network, said information being a Protocol Data Unit (PDU);
(c) inspecting at least one PDU to determine an application corresponding to the PDU; and,
(d) selecting an information path from said plurality of information paths over which to convey the PDU only after said inspecting step.

2. The method recited in claim 1, wherein:
(a) said plurality of information paths include a first virtual circuit and a second virtual circuit, said first virtual circuit having an error correction level different from an error correction level of said second virtual circuit.

3. The method recited in claim 2, including the further step of:
(a) providing said information communication network with at least one switch for operably connecting one of said first virtual circuit and said second virtual circuit to at least one portion of said information communication network to convey the PDU over said one of said first virtual circuit and said second virtual circuit.

4. The method recited in claim 1, wherein:
(a) one of said plurality of information paths has a higher latency than at least one other information path to allow said information path to carry video.

5. The method recited in claim 1, wherein:
(a) said inspecting step is performed prior to conveying the PDU over the Digital Subscriber Loop.

6. A method as recited in claim 1, furthering including the step of:
(a) providing the information communication network with a media classifier for automatically inspecting a PDU and automatically selecting one of said plurality of information paths over which to convey the PDU based on the automatic inspection of the PDU.

7. A method as recited in claim 6, including the further step of:
(a) locating the media classifier at one of a Central Office (CO) and a Broadband Remote Access Server (BRAS).

8. A method as recited in claim 6, further including the steps of:
(a) providing the information communication network with a bandwidth manager for dynamically repartitioning the bandwidth allocated to one or more of said plurality of information paths; and,
(b) providing a signal from the media classifier to the bandwidth manager a unique ID that allows the bandwidth manager to differentiate between traffic activity of separate data streams.

9. A method as recited in claim 6, wherein:
(a) said media classifier includes a Protocol Filter Engine.

10. A method as recited in claim 1, including the further step of:
(a) conveying multiple applications over said information communication network to Customer Premises Equipment (CPE).

11. A method of dynamically re-partitioning the bandwidth allocated to at least one of a plurality of information paths in a information communication network having a Digital Subscriber Loop; said method including the steps of:
(a) in an information communication network having a Digital Subscriber Loop, monitoring over a predetermined time period the utilization of at least one information path to determine if the bandwidth allocated to said information path should be repartitioned; and,
(b) dynamically repartitioning the bandwidth allocated to said information path based on said monitoring step in one of the following manners: (i) reducing the bandwidth of said information path where said information path is underutilized, and (ii) increasing the bandwidth of said information path when there is an increase in traffic on said information path.

12. A method as recited in claim 11, wherein:
(a) said monitoring step includes the sub-steps of (i) starting a timer for each unique stream of information by setting a counter to a predetermined positive constant; (ii) decrementing the counter towards zero; and, (iii) resetting said timer to said predetermined constant each time a new signal is received from an exiting unique stream of information.

13. A method as recited in claim 11, wherein:
(a) said monitoring step includes analyzing input signals to a digital filter and an output of the digital filter for the predetermined time period to obtain an estimate of bandwidth requirement.

14. A method as recited in claim 13, wherein:
(a) the input signal includes a unique ID and a value indicating size of a PDU.

15. A method as recited in claim 11, wherein:
(a) the input signal includes a value representing depth of a data queued in a buffer less a provisioned buffer target depth.

16. An apparatus for delivering information, said apparatus comprising:
(a) an information communication network including a Digital Subscriber Loop for delivering information, said information communication network including a plurality of information paths, each of said plurality of information paths having at least one characteristic differentiating one information path from another information path, said information being a Protocol Data Unit (PDU); and,
(c) a media classifier for inspecting at least one PDU to determine an application corresponding to the PDU and automatically selecting an information path from said plurality of information paths over which to convey the PDU based on the inspection of the at least one PDU.

17. An apparatus as set forth in claim 16, further including:
(a) a switch operably connected to said media classifier.

18. An apparatus as set forth in claim 16, wherein:
(a) one of said plurality of information paths has a sufficiently high latency to carry video.

19. An apparatus as set forth in claim 18, wherein:
(a) one of said plurality of information paths has a sufficiently low latency to carry internet gaming.

20. An apparatus as set forth in claim 16, further including:
(a) a bandwidth manager for dynamically repartitioning the bandwidth allocated to said plurality of information paths.
